(19) United States
(12) Patent Application Publication
(10) Pub. No.: US 2011/0089387 A1
(43) Pub. Date: Apr. 21, 2011

(54) Phase change materials with improved fire-retardant properties

(76) Inventors: Michael Trevor Berry, West Cheshunt (GB); Janet Susan Scanlon, West Cheshunt (GB)

(21) Appl. No.: 12/778,323

(22) Filed: May 12, 2010

(30) Foreign Application Priority Data
Oct. 15, 2009 (GB) 0918061.3

(51) Int. Cl. C09K 21/04

(52) U.S. Cl. 252/602

(57) ABSTRACT

The present invention provides latent heat storage materials having enhanced fire-retardant properties. These include compositions a phase change material and a binder, the binder including dry inert powder, phosphogypsum, and an alkaline salt of any metal. The latent heat storage material may additionally comprise magnesia cement including magnesium oxide, magnesium chloride, and water. The latent heat storage material may additionally comprises fillers, and/or intumescent agents. The phase change material may be a microencapsulated formulation. A process for making these compositions is disclosed.

### CROSS-REFERENCE TO RELATED APPLICATIONS

This application claims the benefit of U.K. Patent Application No. GB0918061.3, filed Oct. 15, 2009.

### BACKGROUND OF THE INVENTION

This invention relates to thermal energy storage compositions that incorporate organic phase change materials and have improved fire retardant properties. The compositions can be incorporated into a variety of articles including for instance foams, heating and cooling devices, and building materials.

Phase change materials and compositions are well known: these are materials which reversibly undergo a change of state and act as a sink for thermal energy, absorbing or releasing heat as necessary. For example, they can be used to regulate temperatures within a desired range, or provide a degree of protection against extremes of heat or cold.

Paraffin wax and similar organic compounds have been used as phase change materials for building applications (such as in wallboards, sheetrock, drywall, plasterboard, and fibreboard for absorbing or releasing heat energy into or from a room environment). However, these materials are flammable: this is particularly true for phase change materials comprising various readily combustible paraffins. This is a major drawback since it increases the combustibility of the articles.

There have been a wide variety of attempts to make the microcapsules more flame-resistant. U.S. Pat. No. 5,435,376 describes microencapsulated latent-heat storage materials which are not combustible. However, non-combustible latent-heat storage materials of this type generally store an insufficient amount of heat. The specification furthermore discloses mixtures of latent-heat storage materials and flame inhibitors as capsule core for textiles, shoes, boots and building insulation. This admixture of flame retardants only results in a slight improvement in the combustion values, or none at all.

U.S. Patent Appl. Pub. No. 2003/0211796A1 discloses an approach that involves coating articles containing microencapsulated organic latent-heat storage materials with a flame-inhibiting finish comprising intumescent coating materials of the type used as flame-inhibiting finishes for steel constructions, ceilings, walls, wood and cables. Their mode of action is based on the formation of an expanded, insulating layer of low-flammability material which forms under the action of heat and which protects the substrate against ingress of oxygen and/or overheating and thus prevents or delays the burning of combustible substrates. Conventional systems consist of a film-forming binder, a char former, a blowing agent and an acid former as essential components. Char formers are compounds which decompose to form carbon (carbonization) after reaction with the acid liberated by the acid former. Such compounds are, for example, carbohydrates, such as mono-, di- and tri-pentaerythritol, polycondensates of pentaerythritol, sugars, starch and starch derivatives. Acid formers are compounds having a high phosphorus content which liberate phosphoric acid at elevated temperature. Such compounds are, for example, ammonium polyphosphates, urea phosphate and diammonium phosphate. Preference is given to polyphosphates since they have a greater content of active phosphorus. Blowing agents, the foam-forming substances, liberate non-combustible gas on decomposition. Blowing agents are, for example, chlorinated paraffins or nitrogen-containing compounds, such as urea, dicyanamide, guanidine or crystalline melamine. It is advantageous to use blowing agents having different decomposition temperatures in order to extend the duration of gas liberation and thus to increase the foam height. Also suitable are components whose mode of action is not restricted to a single function, such as melamine polyphosphate, which acts both as acid former and as blowing agent. Further examples are described in GB2007689A, EP139401A, and U.S. Pat. No. 3,969,291.

Magnesia cement-based products are known to have good fire-resistance, for example, European Patent Application Number EP2060389A1 describes a laminate panel for flooring, wall or ceiling systems having a fire-proof core layer disposed between an upper surface layer and a lower backing layer. The core layer comprises a composition derived from a colloidal mixture of magnesium oxide, magnesium chloride and water.

A publication by Dr Mark A. Shand entitled “Magnesia Cements”, referred to in WO2009/059908, details the three main types of magnesia cements, one of which is the Magnesium Oxychloride cement, otherwise known a Sorel cement. Shand suggests that superior mechanical properties are obtained from the “5-form” whose formula is given as 5Mg(OH)₂.MgCl₂.8H₂O. According to Shand, this is formed using magnesium oxide, magnesium chloride and water in a molar ratio of 5:1:13.

WO2008/063904 discloses an approach for making the five-phase magnesium oxychloride cement composition (5Mg(OH)₂.MgCl₂.8H₂O) by mixing a magnesium chloride brine solution with a magnesium oxide composition in a selected stoichiometric ratio of magnesium chloride, magnesium oxide, and water. The cement kinetics are controlled to form the five-phase magnesium oxychloride cement composition and results in an improved and stable cement composition. The key element would appear to be the utilisation of a magnesium chloride brine solution having a specific gravity in the range from about 28° Baumé to about 34° Baumé, most preferably at least about 30° Baumé. After 24 h, at least 98% of the five-phase compound is present, which minimises the amount of poorly water-resistant three-phase compound. Various fillers can be optionally added to give fire-proofing compositions.

Use of magnesia cement and related components is disclosed in WO2009/059908, which is concerned with the fire retardation properties of compositions including those comprising phase change material and magnesia cement. A high concentration of the 5-form is said to be preferable in inventive compositions comprising Sorel cement where superior mechanical properties are needed. The process for making these materials involves adding the phase change material to the magnesium chloride brine solution before the formation of the magnesium oxychloride cement is initiated by adding the magnesium oxide powder. These magnesia cements containing the phase change material (Examples 1 and 10-13) have molar ratios of magnesium oxide:magnesium chloride:water in the range of between about 5:1:12 (Examples 1, 10 and 11) to 8:1:16 (Examples 12 and 13).

GB2344341A discloses a forming mixture comprising a dry, inert powder, such as fly ash, pulverised rock or recycled building waste, phosphogypsum and an alkaline salt. Additives such as cellulose derivatives, pva resin, microfibres, starch ethers, water repelling agents, colour or flame-retardants, may be included. An aerating agent e.g. a carbonate may be added to yield thermally insulating materials. The addition of a phase change material is not contemplated.

U.S. Pat. Nos. 6,099,894, 6,171,647 and 6,270,836 describe a magnesium oxide gel and other metal oxide gels as a coating for microencapsulated phase change, which result in improved flame protection of the capsules.

### BRIEF SUMMARY OF THE INVENTION

From the foregoing, it may be appreciated that a need has arisen for products that allow for a reduction in the consumption of energy derived from fossil fuels, and which can be manufactured in a way that has a low impact on the environment. Phase change materials work by absorbing heat from a room where the temperature exceeds a comfortable working environment. The heat is stored as latent heat and thermal mass, and released as the temperature of the building falls. This is a continuous cycle involving no mechanical intervention.

According to various, but not necessarily all, embodiments of the invention there is provided a latent heat storage material having improved fire-retardant properties and including a phase change material and a binder, the binder including dry inert powder, phosphogypsum, and an alkaline salt of any metal. The latent heat storage material may additionally comprise magnesia cement including magnesium oxide, magnesium chloride, and water. The latent heat storage material may additionally comprises fillers, and/or intumescent agents. The phase change material may be a microencapsulated formulation

According to various, but not necessarily all, embodiments of the invention there is provided a process for making a latent heat storage material comprising a phase change material and a binder, the binder including dry inert powder, phosphogypsum, and an alkaline salt of any metal, having the steps: (a) mixing the binder and water for 5-10 minutes at high speed; (b) adding phase change material and continuing to mix for a further 10-15 minutes; (c) and baking the mixture. The water may include magnesium chloride and magnesium oxide and is made according to the steps: (i) dissolving magnesium chloride in water; and (ii) adding magnesium oxide to said magnesium chloride solution. The latent heat storage material may additionally comprises fillers, and/or intumescent agents. The phase change material may be a microencapsulated formulation.

The composition may also comprise quartz, perlite or graphite and used to cast floor tiles, wall tiles, lightweight foamed concrete for floor screeds, work tops, panel sections, building blocks, furniture, architectural mouldings for interior and exterior applications, isolated telecommunication rooms or housing units, doors, skirtings, architraves, sleeving for heating and ventilation pipe work or ducting, and construction boards (aluminium or copper mesh to be added to the casting).

### DETAILED DESCRIPTION OF THE INVENTION

Embodiments of the latent heat storage compositions of the present invention and their technical advantages may be better understood by referring to the following disclosure.

In a first step magnesium chloride is dissolved in water of reasonable purity (such as tap water) by mixing for a minimum of 15 minutes at high speed and then left for a minimum of 24 hours to ensure that the magnesium chloride is completely dissolved. The dissolution step is performed under ambient conditions, typically 10-13° C. for the tap water and 15-18° C. for the resulting solution. Magnesium chloride hexahydrate preparations are commercially available and suitable for use in the present invention. For example NEDMAG® C flakes, which are small white flakes of magnesium chloride hexahydrate (MgCl2.6H2O) with a MgCl2 content of 47%, are available from Nedmag Industries Mining & Manufacturing B.V. The Baumé is measured in order to be able to determine the quantity of magnesium oxide to be added in the next step (see below). The proportion of magnesium oxide in the binder affects its density and to some extent determines the quantity of the phase change material and thus the enthalpy measure of the finished binder. The Baumé measures the density of a liquid, which can be either heavier or lighter than water. In the case of the present invention, the liquid density is heavier than water. Typically the weight ratio of magnesium chloride:water is about 1:1, which gives a Baumé reading of 26°; this corresponds to a molar ratio of magnesium chloride:water of about 1:17. The preferred Baumé range is between 1523° and 26°.

In a second step magnesium oxide is added to the magnesium chloride solution prepared in the first step and stirred for a minimum of 10 minutes with a high speed paddle drill. Magnesium oxide preparations are commercially available and suitable for use in the present invention. For example, Baymag magnesium oxide is available from Baymag Inc. and comprises 94-98% (wt/wt) of magnesium oxide and 1.5-4% (wt/wt) of calcium oxide.

In a third step the phase change material (pcm) is added directly after the MgO:MgCl solution has been stirred for at least 15 minutes, and is mixed vigorously. This differs from the process disclosed in WO2009/059908 in which the pcm is added to the magnesium chloride solution. Preferred pcm's are organic, water insoluble materials that undergo solid-liquid/liquid-solid phase changes at temperatures in the range of 0° to 80° C. Candidate materials include substantially water insoluble fatty alcohols, glycols, ethers, fatty acids, amides, fatty acid esters, linear hydrocarbons, branched hydrocarbons, cyclic hydrocarbons, halogenated hydrocarbons and mixtures of these materials. Alkanes (often referred to as paraffins), esters and alcohols are particularly preferred. Alkanes are preferably substantially n-alkanes that are most often commercially available as mixtures of substances of different chain lengths, with the major component, which can be determined by gas chromatography, between C₁₀ and C₅₀, usually between C₁₂ and C₃₂. Examples of the major component of an alkane organic phase change materials include n-octacosane, n-docosane, n-eicosane, n-octadecane, n-heptadecane, n-hexadecane, n-pentadecane and n-tetradecane. It is also possible to include a halogenated hydrocarbon along with the main organic phase change material to provide additional fire protection, for example as disclosed in U.S. Pat. No. 5,435,376. Suitable ester organic phase change materials comprise of one or more C₁-C₁₀ alkyl esters of C₁₀-C₂₄ fatty acids, particularly methyl esters where the major component is methyl behenate, methyl arachidate, methyl stearate, methyl palmitate, methyl myristate or methyl laurate. Alcohol organic phase change materials include one or more alcohols where the major component is, for example, n-decanol, n-dodecanol, n-tetradecanol, n-hexadecanol, and n-octadecanol. These materials are substantially water insoluble, which means they can be formulated in an emulsion form or encapsulated form.

Including a phase change material in the binder mix decreases its fire resistant properties and also alters the physical characteristics of the binder when cured. It is therefore desirable that the enthalpy of phase change is high (typically >50 kJ/kg, preferably >100 kJ/kg and most preferably >150 kJ/kg) so that smaller quantities of pcm can be used in the binder. Preferably, the phase change material is a commercially available encapsulated formulation, such as Micronal®, which has an enthalpy of 110 kJ/kg or Encapsulance, which has a higher enthalpy, in the range of 150-160 kJ/kg. These materials are provided in granular form and may be added to the magnesia cement binder straight out of the container. Using a weight ratio of magnesia cement materials:pcm in the range of 1:2 to 1:3 gives a binder product having an enthalpy measure of about 50 kJ/kg. The quantity of pcm used is chosen so that the enthalpy measure of the binder is at or below 50 kJ/kg. This typically corresponds to a minimum European fire rating of Euroclass D, which is described as having an “Acceptable contribution to fire” (the class system is rated on a scale of A1, A2, B, C, D, E and F, where A1 has no contribution to fire and where F has no performance requirements).

In a fourth step the mixture, which provides a heat absorbing material that in its liquid state, is typically moulded or cast to suit any shape or form for use and baked for no more than 24 h at about 40° C. so that the binder composition dries slowly.

Some Examples of pcm/magnesia cement binder compositions, and the corresponding molar ratios for the magnesia, are given in Tables 1 to 3.

TABLE 1
Where the Baumé of the Solution is 26°:

| | Example 1 | Example 2 |
|---|---|---|
| NEDMAG(RTM) MgCl2 (g) | 500 | 500 |
| Water (g) | 500 | 500 |
| Baymag MgO - comprising | 400 | 250 |
| of: | | |
| Magnesium Oxide: 94-98% (wt.wt) | | |
| Calcium Oxide: 1.5-4% | | |
| BASF Micronal mPCM | 600 | 600 |
| Enthalpy Measure (kJ/kg) | 29.5 | 48.9 |
| Euroclass Fire Rating | C | D |

TABLE 2
Where the Baumé of the Solution is 23°:

| | Example 3 | Example 4 |
|---|---|---|
| NEDMAG(RTM) MgCl2 (g) | 262 | 262 |
| Water (g) | 338 | 338 |
| Baymag MgO - comprising | 250 | 50 |
| of: | | |
| Magnesium Oxide: 94-98% (wt.wt) | | |
| Calcium Oxide: 1.5-4% | | |
| CIBA Encapulance mPCM | 1000 | 1000 |
| Enthalpy Measure (kJ/kg) | 68.1 | 102.6 |
| Euroclass Fire Rating | E | E/F |

TABLE 2a
Where the Baumé of the Solution is 19°:

| | Example 4a |
|---|---|
| Nedmag MgCl2 (grams) | 1000 |
| Water (grams) | 1800 |
| Baymag MgO - comprising | 1000 |
| of: | |
| Magnesium Oxide: 94-98% (wt.wt) | |
| Calcium Oxide: 1.5-4% | |
| BASF Micronal mPCM | 1500 |
| Enthalpy Measure (kJ/kg) | 72.8 |

In another Example (Example 4b), the magnesium chloride solution is prepared from 1000 g Nedmag and 2300 g water, giving a Baumé value of 15° and corresponding to a molar ratio of magnesium chloride:water of 1:32.0. In a further Example (Example 4c), the magnesium chloride solution is prepared from 1000 g Nedmag and 1400 g giving a Baumé value of 22° water and corresponding to a molar ratio of magnesium chloride:water of 1:21.8.

TABLE 3
Molar ratios for MgO:MgCl2:H2O and weight ratios for
cement:pcm in Examples 1-4a

| | Exam- | | | | Enthal- | Euro- | |
|---|---|---|---|---|---|---|---|
| Baumé | ple | MgO | MgCl₂ | H₂O | py | class | Cement:pcm |
| 26° | 1 | 4.0 | 1.00 | 17.3 | 29.5 | C | 2.3 |
| 26° | 2 | 2.5 | 1.00 | 17.3 | 48.9 | D | 2.1 |
| 23° | 3 | 4.8 | 1.00 | 20.6 | 68.1 | E | 0.85 |
| 23° | 4 | 1.0 | 1.00 | 20.6 | 102.6 | E/F | 0.65 |
| 19° | 4a | 5.0 | 1.00 | 26.3 | 72.8 | | 2.53 |
| 15° | 4b | | 1.00 | 32.0 | | | |
| 22° | 4c | | 1.00 | 21.8 | | | |

In Examples 1 and 2, the molar ratio of magnesium chloride:water is 1:17.3, corresponding to a Baumé value of 26°, and in Examples 3 and 4, the molar ratio of magnesium chloride:water is 1:20.6, corresponding to a Baumé value of 23°. This is lower than the Baumé value of 28° to 34° taught in WO2008/063904. In Example 4c, the molar ratio of magnesium chloride:water is 1:21.8, corresponding to a Baumé value of 22°. In Example 4a, the molar ratio of magnesium chloride:water is 1:26.3, corresponding to a Baumé value of 19°. In Example 4b, the molar ratio of magnesium chloride:water is 1:32.0, corresponding to a Baumé value of 15°.

In Examples 1, 3 and 4a the molar ratio of magnesium chloride:magnesium oxide is between about 1:4 and 1:5. The molar ratio of MgO:MgCl2:H2O in the magnesia cement of the present invention thus varies in the ranges 4-5:1:17.3-26.3. This is considerably different from the magnesia cements utilised in Examples 10 and 11 of WO2009/059908 (a ratio of 5.3:1:12) and Examples 12 and 13 of WO2009/059908 (a ratio of 8:1:16).

The molar ratio of the added magnesium oxide:magnesium chloride is generally in the range of about 4:1 to about 5:1, but much lower molar ratios (as low as about 1:1) are utilised when a larger quantity of phase change material is to be incorporated into the binder as in Examples 2 and 4. The greater the volume of phase change material that can be incorporated into the present invention, the higher the enthalpy measure and subsequently the greater the heat storage capacity of the material. In addition, where the Baumé of the solution is reduced to 23°, the volume of magnesium oxide in the binder is also reduced as a result (to keep the molar ratio of magnesium chloride:magnesium oxide in the same range) as in Example 4. Therefore a higher volume of phase change material can be incorporated into the mixture. The increase in water content of the solution will evaporate during the curing stages of the binder/mixture.

For the high Baumé formulations of Examples 1 and 2, a weight ratio of magnesia cement materials:pcm in the range of 1:2 to 1:3 gives a binder product having an enthalpy measure of about 50 kJ/kg. For the lower Baumé formulation of Example 4a, a weight ratio of magnesia cement materials:pcm in the same range gives a binder product having an enthalpy measure of about 70 kJ/kg. The binder product of the present invention is thus rather superior to that disclosed in WO2009/059908 in which the weight ratio of magnesia cement materials:pcm in the range of 1:0 to 1:2 and the enthalpy measures are in the range of 13 to 33 kJ/kg.

The microencapsulated phase change material alone is highly flammable, and in Examples 3 and 4 the Euroclass fire rating is low: casting the mixture into aluminium, copper or graphite encasements prior to baking protects the binder from fire and give the binder a practical format with high thermal conductivity benefits for a number of applications.

In a second embodiment of the present invention in which a high enthalpy is secondary to the density and strength requirements, aggregate fillers such as, but not limited to, silica sand, stone dust, quartz, perlite, marble, ceramic powders, or graphite can be added to the binder with phase change material mixture. This gives the material additional strength and durability characteristics for other applications where aluminium, copper or graphite casing are not necessary or practical. Table 4 provides details of formulations containing quartz, and the corresponding molar ratios for the magnesia are given in Table 5.

TABLE 4
Where the Baumé of the Solution is 26° and incorporating
Quartz into Binder mixture

| | Example 5 | Example 6 |
|---|---|---|
| NEDMAG(RTM) MgCl2 (g) | 150 | 500 |
| Water (g) | 150 | 500 |
| Baymag MgO - comprising | 150 | 400 |
| of: | | |
| Magnesium Oxide: 94-98% (wt.wt) | | |
| Calcium Oxide: 1.5-4% | | |
| CIBA Encapulance mPCM | 150 | 600 |
| Quartz | 150 | 100 |
| Enthalpy Measure (kJ/kg) | 48.8 | 47.0 |
| Euroclass Fire Rating | C | C |

TABLE 5
Molar ratios for MgO:MgCl₂:H₂O and weight ratios for
cement:pcm in Examples 5 and 6

| | Exam- | | | | Enthal- | Euro- | |
|---|---|---|---|---|---|---|---|
| Baumé | ple | MgO | MgCl₂ | H₂O | py | class | Cement:pcm |
| 26° | 5 | 5.0 | 1.00 | 17.3 | 48.8 | C | 3.0 |
| 26° | 6 | 4.0 | 1.00 | 17.3 | 47.0 | C | 2.3 |

The molar ratio of MgO:MgCl₂:H₂O in the magnesia cement of this second embodiment thus varies in the ranges 4-5:1:17.3, considerably different from the magnesia cements utilised in Examples 10 and 11 of WO2009/059908 (a ratio of 5.3:1:12) and Examples 12 and 13 of WO2009/059908 (a ratio of 8:1:16).

Prior to the baking step, these formulations can be cast to form wall and floor tiles, floor coatings and screeds, worktops, furniture, exterior cladding and siding panels, construction boards and building blocks and internal and external architectural mouldings. Also organic fillers including, but again not limited to, wood dust, flax sheaves, hemp and straw can be added as fillers in the manufacture of a construction board for interior/exterior walls and also ceilings.

In a third embodiment in which the enthalpy of the binder exceeds 50 kJ/kg, the fire rating reduces to Euroclasses E and F and is therefore limited in its use as a building material. In order to overcome this, intumescent agent of the type disclosed in U.S. Patent Appl. Pub. No. 2003/0211796A1 is added, again with mixing, to the binder and phase change material mixture. Typical intumescents are latex aqueous dispersions. Preferred intumescents include Thermasorb and A/D Firefilm III from Carboline, which are water-based intumescents. Example 8 shows how the addition of Thermasorb alters the

Euroclass Fire Rating for a magnesia cement containing Encapsulance from E (Example 7 in the absence of Thermasorb) to C.

TABLE 6
Where the Baumé of the Solution is 26° and incorporating
intumescent into the Binder mixture of example 8 only.

| | Example 7 | Example 8 |
|---|---|---|
| NEDMAG(RTM) MgCl2 (g) | 300 | 300 |
| Water (grams) | 300 | 300 |
| Baymag MgO - comprising | 250 | 250 |
| of: | | |
| Magnesium Oxide: 94-98% (wt.wt) | | |
| Calcium Oxide: 1.5-4% | | |
| CIBA Encapulance mPCM | 1000 | 1000 |
| Intumescent - Carboline | 0 | 200 |
| Thermasorb (grams) | | |
| Enthalpy Measure (kJ/kg) | 66.3 | 48.9 |
| Euroclass Fire Rating | E | C |

TABLE 7
Molar ratios for MgO:MgCl₂:H₂O and weight ratios for
cement:pcm in Examples 7 and 8

| | Exam- | | | | Enthal- | Euro- | |
|---|---|---|---|---|---|---|---|
| Baumé | ple | MgO | MgCl₂ | H₂O | py | class | Cement:pcm |
| 26° | 7 | 4.20 | 1.00 | 17.3 | 66.3 | E | 0.85 |
| 26° | 8 | 4.20 | 1.00 | 17.3 | 48.9 | C | 0.85 |

For high enthalpy binders with poor Euroclass Fire Ratings, the mixtures are cast into an encasement that preferably comprises aluminium or copper or a combination thereof prior to the baking step. These materials have good thermal conductivity (aluminium—237 (W/m k), copper—401 (W/m k) as apposed to other encasements made with plain steel, for an example, which has a thermal conductivity value of 45-65 (W/m k). They therefore maximise the efficiency of the phase change material.

The encasements can be formed into embodiments including, but not limited to, ceiling tiles, chilled ceiling systems, heating and cooling exchange units, wall panels, computer room floor tiles, raised access floor panels, curtain walling sections, suspended ceiling sections, extrusions for lightweight concrete floors, window and door frames, sleeving for heating and ventilation pipe work or ducting, and telecommunication and data rooms.

In a fourth embodiment, a binder formulation having very high enthalpy, for example over 100 kJ/kg, or over 150 kJ/kg, utilising a secondary binder of the type disclosed in GB2344341 (PFA binder) is detailed in Examples 9 and 10.

TABLE 8
Where a secondary binder is utilised.

| | Example 9 | Example 10 | Example 11 |
|---|---|---|---|
| NEDMAG(RTM) MgCl2 (g) | 50 | 44 | 0 |
| Water (g) | 50 | 56 | 100 |
| Baume of MgCl₂:H2O | 26 | 23 | — |
| Solution | | | |
| Baymag MgO (grams) - | 50 | 44 | — |
| comprising of: | | | |
| Magnesium Oxide: 94-98% | | | |
| (wt.wt) | | | |
| Calcium Oxide: 1.5-4% | | | |
| CIBA Encapulance Mpcm | 150 | 150 | 250 |
| (grams) | | | |
| PFA Binder (grams) | 50 | 50 | 50 |
| Enthalpy Measure (kJ/kg) | 144 | 101 | 155 |
| Euroclass Fire Rating | E/F | E/F | F |

TABLE 9
Molar ratios for MgO:MgCl₂:H₂O and weight ratios for
cement:pcm in Examples 9 and 10

| | Exam- | | | | Enthal- | Euro- | |
|---|---|---|---|---|---|---|---|
| Baumé | ple | MgO | MgCl₂ | H₂O | py | class | Cement:pcm |
| 26° | 9 | 5.04 | 1.00 | 17.3 | 144 | E/F | 1.00 |
| 23° | 10 | 5.04 | 1.00 | 20.4 | 101 | E/F | 0.96 |

This gives a binder having a Euroclass fire rating of E/F. This secondary binder comprises dry, inert powder such as fly ash, pulverised rock or recycled building waste, phosphogypsum which is a by product of phosphoric acid production for phosphate fertiliser, and an alkaline salt of any metal and so may also be an industrial waste or by-product, for example, cellulose production. The dry, inert powder may be a major proportion by weight and may comprise 65-85%, preferably 74-76% by weight of the secondary binder. The alkaline salt may comprise 0.2-1.0%, preferably 0.4-0.6% by weight of the secondary binder. By way of example and not restricted to, a secondary compound comprising fly-ash (75%), phosphogypsum (24.5%) and alkaline salt (0.5%) would be preferred for a variety of constructional materials. A suitable secondary binder is available from AMPC International Technologies (Cyprus) Ltd and has the product code IST. It is a quick setting, fireproof, lightweight, high thermal resistance compound.

In the formulation process where a magnesium cement binder and phase change material is used (Examples 9 and 10), the secondary binder is added when both of the aforementioned components have been mixed. It is recommended that the mixture of magnesium cement binder, phase change material and secondary binder is stirred vigorously for a further 10-15 minutes at high speed after the secondary binder has been added. This is to ensure that there is even dispersion of the secondary binder within the mixture. In this formulation, the weight:weight ratio of secondary binder to phase change material is 1:3.

The use of a secondary binder provides components that can be used in cooling systems, both passive and mechanical. These include chilled beam systems, ceiling tiles and computer/raised access floor panels, wall panels for computer data and server rooms, isolated telecommunication rooms. The important aspect of using the secondary binder with the phase change material is that is has to be in an encasement which is made from either aluminium, copper, steel, rigid PVC, timber, plastics, glass, graphite, concrete, and cementitious or gypsum floor screeds.

In a fifth embodiment, inclusion of the secondary binder alone along with the phase change material and therefore excluding the magnesium cement binder yields higher enthalpy results of 150 kJ/kg and above (see Example 11 above). This is because the nature of the secondary binder allows for a higher volume of phase change material by weight to be added to a small volume by weight of the secondary binder. However the drawback of the secondary binder when used in this formulation is that it has limited/non-existent fire resistant properties and therefore will only achieve Euroclass classification F. As such the formulation can only be used in embodiments that consist of an encasement of some description that meets the local or national minimum building regulation standard. An example of encasement materials include but not limited to aluminium, copper, steel, graphite, timber, rigid P.V.C.

Where the formulation does not include the magnesium cement binder, the secondary binder and water are mixed for 5-10 minutes at high speed prior to the phase change material being added. After adding the phase change material the mixture is mixed for a further 10-15 minutes.

In this formulation, the weight ratio of secondary binder to phase change material is 1:5. The average mean enthalpy of preparations of this type are far superior than any achieved using a Sorel cement formulation. However this needs to be encased in aluminium or copper to give fire resistance.

In these high enthalpy embodiments, an intumescent agent of the type described above may also be added.

1. A latent heat storage material having improved fire-retardant properties and including a phase change material and a binder, wherein said binder including dry inert powder, phosphogypsum, and an alkaline salt of any metal.

2. The latent heat storage material of claim 1 wherein said dry inert powder comprises 65-85% by weight of said binder.

3. The latent heat storage material of claim 1 wherein said alkaline salt comprises 0.2-1.0% by weight of said binder.

4. The latent heat storage material of claim 1 wherein said binder comprises 75% by weight of fly-ash, 24.5% by weight of phosphogypsum and 0.5% by weight of alkaline salt.

5. The latent heat storage material of claim 1 additionally comprising an intumescent agent.

6. The latent heat storage material of claim 1 in which the phase change material is in a microencapsulated form.

7. The latent heat storage material of claim 1 additionally comprising a filler material selected from the group consisting of: silica sand, stone dust, quartz, perlite, marble, ceramic powders, wood dust, flax sheaves, hemp, straw and graphite.

8. The latent heat storage material of claim 8 in which said material is cast to form wall tiles, floor tiles, floor coatings, floor screeds, worktops, furniture, exterior cladding and siding panels, construction boards and building blocks and internal and external architectural mouldings.

9. The latent heat storage material of claim 1 additionally including magnesia cement including magnesium oxide, magnesium chloride, and water.

10. The latent heat storage material of claim 9 in which a molar ratio of said magnesium chloride to said water is in the range of 1:17 to 1:32.

11. The latent heat storage material of claim 9 in which a molar ratio of magnesium chloride to magnesium oxide is less than 1:5.

12. The latent heat storage material of claim 9 in which a weight ratio of the magnesia cement to the phase change material is in the range of 0.4:1 to 3:1.

13. The latent heat storage material of claim 9 additionally comprising an intumescent agent.

14. The latent heat storage material of claim 9 additionally comprising a filler material selected from the group consisting of: silica sand, stone dust, quartz, perlite, marble, ceramic powders, wood dust, flax sheaves, hemp, straw and graphite.

15. The latent heat storage material of claim 14 in which said material is cast to form wall tiles, floor tiles, floor coatings, floor screeds, worktops, furniture, exterior cladding and siding panels, construction boards and building blocks and internal and external architectural mouldings.

16. A process for making a latent heat storage material having improved fire-retardant properties and including a phase change material and a binder, said binder including dry inert powder, phosphogypsum, and an alkaline salt of any metal and comprising the steps:
(a) mixing said binder and water for 5-10 minutes at high speed;
(b) adding phase change material and continuing to mix for a further 10-15 minutes; and
(c) baking the mixture.

17. The process of claim 16 wherein said dry inert powder comprises 65-85% by weight of said binder.

18. The process of claim 16 wherein said alkaline salt comprises 0.2-1.0% by weight of said binder.

19. The process of claim 16 wherein said binder comprises 75% by weight of fly-ash, 24.5% by weight of phosphogypsum and 0.5% by weight of alkaline salt.

20. The process of claim 16 additionally comprising the step of adding an intumescent agent.

21. The process of claim 16 in which said water includes magnesium chloride and magnesium oxide and is made according to the steps:
(a) dissolving magnesium chloride in water; and
(b) adding magnesium oxide to said magnesium chloride solution.

22. The process of claim 21 in which a molar ratio of said magnesium chloride to said water is in the range of 1:17 to 1:32.

23. The process of claim 21 in which a molar ratio of said magnesium chloride to said magnesium oxide is less than 1:5.
